(19) United States
(12) Patent Application Publication
(10) Pub. No.: US 2026/0273939 A1
(43) Pub. Date: Sep. 17, 2026

(54) LIQUID RECEIVING DEVICE, MAINTENANCE DEVICE, AND LIQUID EJECTION APPARATUS

(71) Applicant: SEIKO EPSON CORPORATION, TOKYO (JP)

(72) Inventor: Sohei CHIBA, SHIOJIRI-SHI (JP)

(21) Appl. No.: 19/565,663

(22) Filed: Mar. 13, 2026

(30) Foreign Application Priority Data
Mar. 13, 2025 (JP) 2025-040214

(51) Int. Cl. B41J 2/165; B41J 2/17

(52) U.S. Cl. CPC B41J 2/16505; B41J 2/1721; B41J 2002/16594

(57) ABSTRACT

A liquid receiving device that receives a liquid discharged from a liquid ejection head includes: a first absorber configured to absorb the liquid; a second absorber disposed below the first absorber in a vertical direction and configured to absorb the liquid; a plate disposed between the first absorber and the second absorber; and a recess configured to accommodate the first absorber, the second absorber, and the plate, in which the recess has a bottom portion in which a discharge port configured to suction and discharge the liquid is formed, the second absorber has a higher density than the first absorber, and the plate blocks movement of the liquid between the first absorber and the second absorber at a position overlapping the discharge port when viewed in the vertical direction.

### CROSS-REFERENCE TO RELATED APPLICATION

The present application is based on, and claims priority from JP Application Serial Number 2025-040214, filed Mar. 13, 2025, the disclosure of which is hereby incorporated by reference herein in its entirety.

### BACKGROUND

### 1. Technical Field

The present disclosure relates to a liquid receiving device, a maintenance device, and a liquid ejection apparatus.

### 2. Related Art

For example, as in JP-A-11-227225, there is an inkjet recording apparatus, which is an example of a liquid ejection apparatus including a cap, which is an example of a liquid receiving device, a pump, which is an example of a suction portion, and an inkjet head, which is an example of a liquid ejection head.

The cap includes an ink absorbing member. A communication hole, which is an example of a discharge port, is formed in a bottom portion of the cap. The ink absorbing material absorbs ink discharged from the inkjet head.

The ink absorbing member includes a first absorber portion and a second absorber portion. The first absorber portion has small voids. The second absorber portion has large voids. The ink absorbing member covers the communication hole with the first absorber portion. The ink absorbing member concentrates the absorbed ink near the communication hole by a difference in capillary force between the first absorber portion and the second absorber portion. The pump suctions the ink absorbed by the ink absorbing member from the communication hole.

JP-A-11-227225 is an example of the related art.

In the cap of JP-A-11-227225, the communication hole is located at a position close to a side wall. When the communication hole is located at a biased position, even if the ink is collected by the capillary force of the ink absorbing member, it may be difficult to discharge the liquid at a portion far from the communication hole.

### SUMMARY

A liquid receiving device that solves the above problem is a liquid receiving device that receives a liquid discharged from a liquid ejection head and includes: a first absorber configured to absorb the liquid; a second absorber disposed below the first absorber in a vertical direction and configured to absorb the liquid; a plate disposed between the first absorber and the second absorber; and a recess configured to accommodate the first absorber, the second absorber, and the plate, in which the recess has a bottom portion in which a discharge port configured to suction and discharge the liquid is formed, the second absorber has a higher density than the first absorber, and the plate blocks movement of the liquid between the first absorber and the second absorber at a position overlapping the discharge port when viewed in the vertical direction.

A maintenance device that solves the above problem includes: the liquid receiving device having the above configuration; a waste liquid flow path connected to the discharge port; and a suction portion configured to suction the liquid from the recess.

A liquid ejection apparatus that solves the above problem includes: a liquid ejection head configured to eject a liquid; and a liquid receiving device configured to receive the liquid discharged from the liquid ejection head, in which the liquid receiving device includes a first absorber configured to absorb the liquid, a second absorber disposed below the first absorber in a vertical direction and configured to absorb the liquid, a plate disposed between the first absorber and the second absorber, and a recess configured to accommodate the first absorber, the second absorber, and the plate, the recess has a bottom portion in which a discharge port configured to suction and discharge the liquid is formed, the second absorber has a higher density than the first absorber, and the plate blocks movement of the liquid between the first absorber and the second absorber at a position overlapping the discharge port when viewed in the vertical direction.

### BRIEF DESCRIPTION OF THE DRAWINGS

FIG. 1 is a schematic diagram of an embodiment of a liquid ejection apparatus.

FIG. 2 is a schematic cross-sectional view along an arrowed line 2-2 in FIG. 1.

FIG. 3 is a schematic cross-sectional view of a liquid receiving device according to a first modification.

FIG. 4 is a schematic cross-sectional view of a liquid receiving device according to a second modification.

FIG. 5 is a schematic cross-sectional view of a liquid receiving device according to a third modification.

FIG. 6 is a schematic cross-sectional view of a liquid receiving device according to a fourth modification.

### DESCRIPTION OF EMBODIMENTS

### Embodiment

Hereinafter, an embodiment of a liquid receiving device, a maintenance device, and a liquid ejection apparatus will be described with reference to the drawings. The liquid ejection apparatus is an inkjet type printer that ejects ink as an example of a liquid onto a medium such as paper, fabric, a vinyl sheet, a plastic component, or a metal component to perform printing.

In the drawings, assuming that a liquid ejection apparatus 11 is placed on a horizontal plane, the direction of gravity is indicated by a Z axis, and directions along the horizontal plane are indicated by an X axis and a Y axis. The X axis, the Y axis, and the Z axis are perpendicular to each other. In the following description, a direction parallel to the Z axis is also referred to as a vertical direction Z.

### Liquid Ejection Apparatus

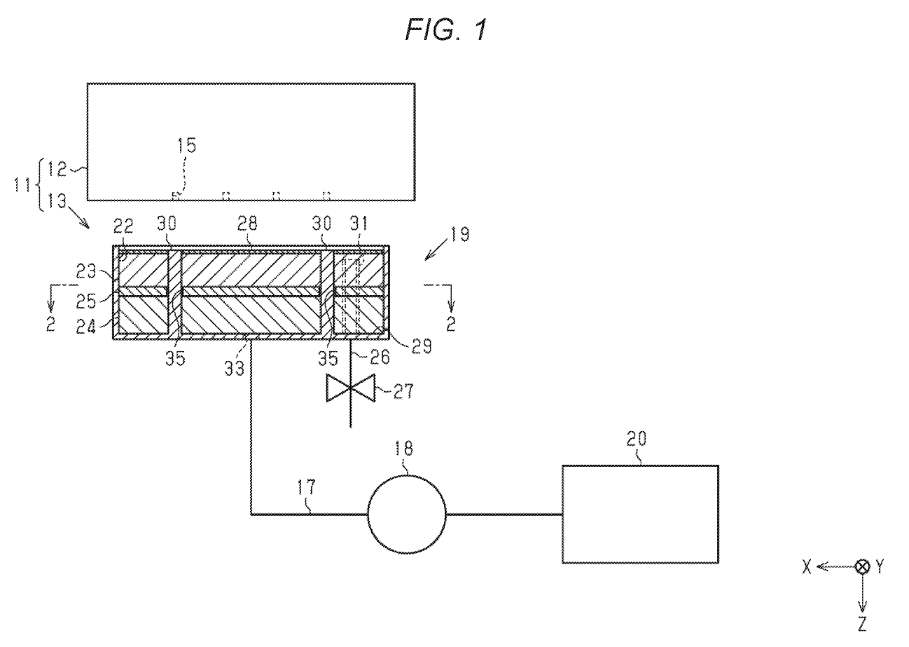

As illustrated in FIG. 1, a liquid ejection apparatus 11 may include a liquid ejection head 12 and a maintenance device 13.

The liquid ejection head 12 can eject a liquid. The liquid ejection head 12 includes one or more nozzles 15. The liquid ejection head 12 ejects the liquid from the nozzles 15 to perform printing on a medium (not illustrated).

### Maintenance Device

The maintenance device 13 may include a waste liquid flow path 17, a suction portion 18, and a liquid receiving device 19. The waste liquid flow path 17 may be connected to a waste liquid container 20. The waste liquid container 20 may be detachably provided with respect to the maintenance device 13.

The waste liquid flow path 17 has an upstream end connected to the liquid receiving device 19 and a downstream end connected to the waste liquid container 20. The waste liquid flow path 17 may be implemented by, for example, a tube that is deformable following the movement of the liquid receiving device 19. The waste liquid flow path 17 can discharge the liquid in the liquid receiving device 19 to the waste liquid container 20. The suction portion 18 may be provided in the waste liquid flow path 17. The suction portion 18 is, for example, a tube pump.

### Liquid Receiving Device

The liquid receiving device 19 receives the liquid discharged from the liquid ejection head 12. The liquid receiving device 19 of the embodiment is a cap capable of forming a closed space in which the nozzle 15 opens by coming into contact with the liquid ejection head 12. The liquid receiving device 19 can receive the liquid discharged from the nozzle 15. The liquid receiving device 19 may include a recess 22, a first absorber 23, a second absorber 24, and a plate 25. The liquid receiving device 19 may include an open-to-atmosphere flow path 26 and an open-to-atmosphere valve 27. The liquid receiving device 19 may include a pressing portion 28.

The recess 22 may accommodate the first absorber 23, the second absorber 24, the plate 25, and the pressing portion 28. The recess 22 may accommodate the second absorber 24, the plate 25, the first absorber 23, and the pressing portion 28 in a stacked state in order from a lower side in the vertical direction Z. The second absorber 24 is disposed below the first absorber 23 in the vertical direction Z. The pressing portion 28 is disposed above the first absorber 23 in the vertical direction Z. The pressing portion 28 presses the first absorber 23 from above in the vertical direction Z. The pressing portion 28 may have, for example, a mesh shape or a lattice shape.

The recess 22 may include a bottom portion 29, one or more columns 30, and an open-to-atmosphere cylinder 31. The recess 22 opens upward in the vertical direction Z.

The bottom portion 29 supports the second absorber 24. A discharge port 33 is formed in the bottom portion 29. The second absorber 24 covers the discharge port 33 from above. The discharge port 33 is for suctioning and discharging the liquid. The waste liquid flow path 17 is connected to the discharge port 33.

The column 30 and the open-to-atmosphere cylinder 31 may extend vertically from the bottom portion 29. At least one of the column 30 and the open-to-atmosphere cylinder 31 may extend in the vertical direction Z. The column 30 and the open-to-atmosphere cylinder 31 may penetrate the first absorber 23, the second absorber 24, and the plate 25, or may penetrate the second absorber 24 and the plate 25. For example, an upper end of the open-to-atmosphere cylinder 31 may be located below an upper surface of the first absorber 23.

The column 30 is for holding the first absorber 23 and the second absorber 24. An upper end of the column 30 may be fixed to the pressing portion 28.

The open-to-atmosphere cylinder 31 is for opening the recess 22 closed by the liquid ejection head 12 to the atmosphere. A part of the open-to-atmosphere flow path 26 is formed in the open-to-atmosphere cylinder 31. The open-to-atmosphere valve 27 is provided in the open-to-atmosphere flow path 26. The open-to-atmosphere valve 27 opens and closes the open-to-atmosphere flow path 26.

The liquid receiving device 19 may be provided to be movable between a capping position (not illustrated) and a separation position illustrated in FIG. 1.

The capping position is a position at which the liquid receiving device 19 is in contact with the liquid ejection head 12. The liquid receiving device 19 located at the capping position forms a closed space by closing the opening of the recess 22 with the liquid ejection head 12. The liquid receiving device 19 located at the capping position caps the liquid ejection head 12.

The separation position is a position where the liquid ejection head 12 is opened. The liquid receiving device 19 located at the separation position is separated from the liquid ejection head 12, and the opening of the recess 22 is opened. The liquid receiving device 19 located at the separation position sets a space in the recess 22 as an open space.

The first absorber 23 and the second absorber 24 can absorb liquid. The second absorber 24 has a higher density than the first absorber 23. The density of the first absorber 23 and the second absorber 24 may be a weight per volume. The second absorber 24 may have a smaller void than the first absorber 23.

The plate 25 is disposed between the first absorber 23 and the second absorber 24. The plate 25 is located above the discharge port 33. The second absorber 24 is located between the plate 25 and the discharge port 33. The plate 25 covers at least a portion of the second absorber 24 located above the discharge port 33 from above. The plate 25 blocks the movement of the liquid between the first absorber 23 and the second absorber 24 at a position overlapping the discharge port 33 when viewed in the vertical direction Z.

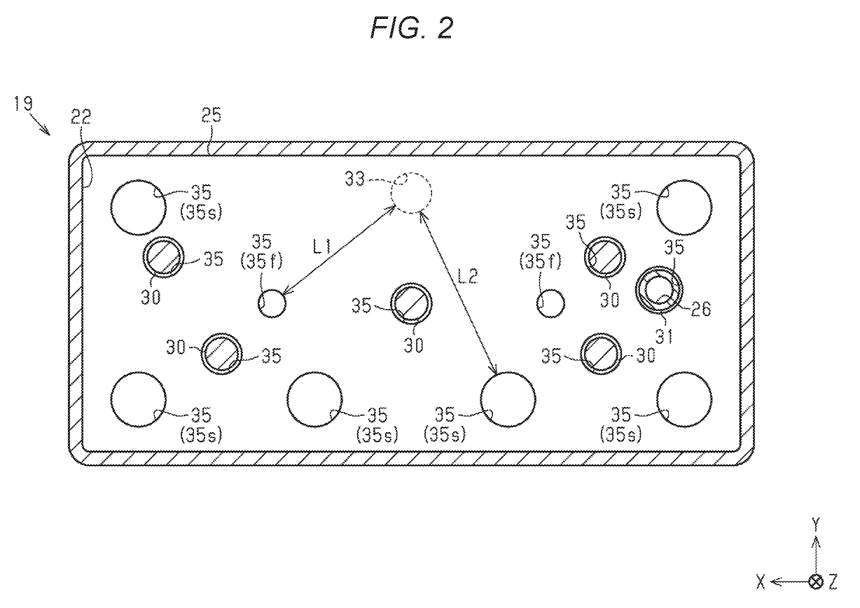

As illustrated in FIG. 2, the shape of the plate 25 may match the shape of the recess 22. The plate 25 may have a quadrangular shape in a plan view. Corners of the plate 25 may be rounded. The plate 25 of the embodiment has a rectangular shape. In the embodiment, a direction in which a long side of the plate 25 extends is also referred to as a longitudinal direction X, and a direction in which a short side of the plate 25 extends is also referred to as a transverse direction Y. The longitudinal direction X is a direction along the X axis. The transverse direction Y is a direction along the Y axis. The longitudinal direction X and the transverse direction Y are also horizontal directions. The plate 25 may have the same size as the recess 22 in each of the longitudinal direction X and the transverse direction Y. Each side surface of the plate 25 may be in contact with a side surface of the recess 22.

The plate 25 may have a plurality of holes 35 at positions not overlapping the discharge port 33 when viewed in the vertical direction Z. The plurality of holes 35 are located at positions not overlapping the discharge port 33 in at least one of the longitudinal direction X and the transverse direction Y. The first absorber 23 and the second absorber 24 may be in contact with each other through the hole 35.

At least one of the plurality of holes 35 may be a hole 35 through which the column 30 passes. The diameter of the hole 35 through which the column 30 passes may be larger than the diameter of the column 30. A gap may be formed between an inner surface of the hole 35 and the column 30.

One of the plurality of holes 35 may be the hole 35 through which the open-to-atmosphere cylinder 31 passes. The size of the hole 35 through which the open-to-atmosphere cylinder 31 passes may be larger than the diameter of the open-to-atmosphere cylinder 31. A gap may be formed between the inner surface of the hole 35 and the open-to-atmosphere cylinder 31.

The plurality of holes 35 may include one or more first holes 35f and one or more second holes 35s. The first hole 35f and the second hole 35s may be circular in the plan view. The diameter of the second hole 35s is larger than the diameter of the first hole 35f. When a distance from the discharge port 33 to the first hole 35f is a first distance L1, a second distance L2 from the discharge port 33 to the second hole 35s is larger than the first distance L1.

At least one of the plurality of holes 35 may be located at a corner portion of the plate 25. The corner portion of the plate 25 may be a portion between the corner of the plate 25 and one column 30 located at a position closest to the corner. A distance of the hole 35 located at the corner portion from the corner of the plate 25 is shorter than a distance from the center of the plate 25. In the embodiment, the second holes 35s are located at four corner portions of the plate 25.

### Action of Embodiment

Action of the embodiment will be described.

As illustrated in FIG. 1, the suction portion 18 can depressurize the space in the recess 22 via the waste liquid flow path 17. The maintenance device 13 performs suction cleaning of discharging the liquid from the nozzle 15 by causing the suction portion 18 to decompress the inside of the recess 22 in a state where the liquid receiving device 19 is located at the capping position. The liquid discharged from the nozzle 15 is received by the first absorber 23. Since the first absorber 23 has a low density, the first absorber 23 can quickly take in the liquid in contact therewith.

The maintenance device 13 stops the suction portion 18 while the liquid receiving device 19 is located at the capping position. Subsequently, after a certain time elapses, the maintenance device 13 causes the open-to-atmosphere valve 27 to open the open-to-atmosphere flow path 26 while the liquid receiving device 19 is located at the capping position. When the open-to-atmosphere flow path 26 is opened, the atmosphere flows into the recess 22 closed by the liquid ejection head 12. The open-to-atmosphere cylinder 31 sets a space between the first absorber 23 and the liquid ejection head 12 to an atmospheric pressure. The atmospheric pressure is applied to the liquid absorbed by the first absorber 23.

The maintenance device 13 drives the suction portion 18 again. The suction portion 18 depressurizes the inside of the recess 22 from the discharge port 33. When the suction portion 18 is driven, air flows into the recess 22 via the open-to-atmosphere cylinder 31.

The discharge port 33 is covered with the second absorber 24. The second absorber 24 is covered with the plate 25. Therefore, a depressurizing force is transmitted to the first absorber 23 via the hole 35. The depressurizing force transmitted to the first absorber 23 decreases as a distance from the discharge port 33 increases. The depressurizing force transmitted to the first absorber 23 increases as the size of the hole 35 increases. Among the holes 35 of the embodiment, the first hole 35f close to the discharge port 33 is small, and the second hole 35s far from the discharge port 33 is large. The plate 25 reduces the bias of the depressurizing force applied to the first absorber 23.

Since the first absorber 23 has a low density, for example, when a large depressurizing force acts on a part of the first absorber 23, the liquid is easily separated in the first absorber 23. That is, the liquid is likely to remain in the first absorber 23. However, since the plate 25 of the embodiment causes the depressurizing force to act on the first absorber 23 in a distributed manner, the liquid remaining in the first absorber 23 can be reduced. The liquid held in the first absorber 23 moves to the second absorber 24 through the hole 35. Since the second absorber 24 has a high density, it is difficult to separate the liquid absorbed by the second absorber 24 even when a large depressurizing force acts on the second absorber 24. The liquid moves in the second absorber 24 and is discharged from the discharge port 33. That is, the suction portion 18 suctions the liquid from the recess 22.

### Effects of Embodiment

Effects of the embodiment will be described.

(1-1) The plate 25 blocks movement of the liquid between the first absorber 23 and the second absorber 24. The movement of the liquid absorbed by the first absorber 23 from the first absorber 23 to the second absorber 24 is blocked at a position above the discharge port 33. Therefore, the liquid absorbed by the first absorber 23 moves to the second absorber 24 so as to bypass the plate 25. Therefore, it is possible to discharge the liquid while reducing the influence of the distance from the discharge port 33.

(1-2) Since the shape of the plate 25 matches the shape of the recess 22, the position of the plate 25 accommodated in the recess 22 can be easily determined. The plate 25 has the plurality of holes 35. Since the liquid moves from the first absorber 23 to the second absorber 24 via the plurality of holes 35, a path of the liquid can be easily specified.

(1-3) It is difficult to discharge the liquid absorbed in the portion away from the discharge port 33. The at least one hole 35 is located at the corner portion of the plate 25. Therefore, the liquid in the portion that is difficult to discharge can be efficiently discharged.

(1-4) The second holes 35s far from the discharge port 33 are larger than the first holes 35f close to the discharge port 33. Since the large hole 35 is located in the portion that is difficult to discharge, the liquid in the portion that is difficult to discharge can be efficiently discharged.

(1-5) The column 30 holds the first absorber 23 and the second absorber 24. Therefore, deviation between the first absorber 23 and the second absorber 24 can be suppressed. The column 30 penetrates the hole 35 of the plate 25. Therefore, the movement of the liquid along the column 30 can be allowed.

(1-6) The recess 22 has the open-to-atmosphere cylinder 31. Therefore, the pressure can be regulated even in a state of being blocked by the liquid ejection head 12. The open-to-atmosphere cylinder 31 penetrates the hole 35 of the plate 25. Therefore, the movement of the liquid along the open-to-atmosphere cylinder 31 can be allowed.

### Modifications

The embodiment can be implemented with the following modifications. The embodiment and the following modifications can be implemented in combination with each other as long as no technical inconsistencies are involved.

### First Modification

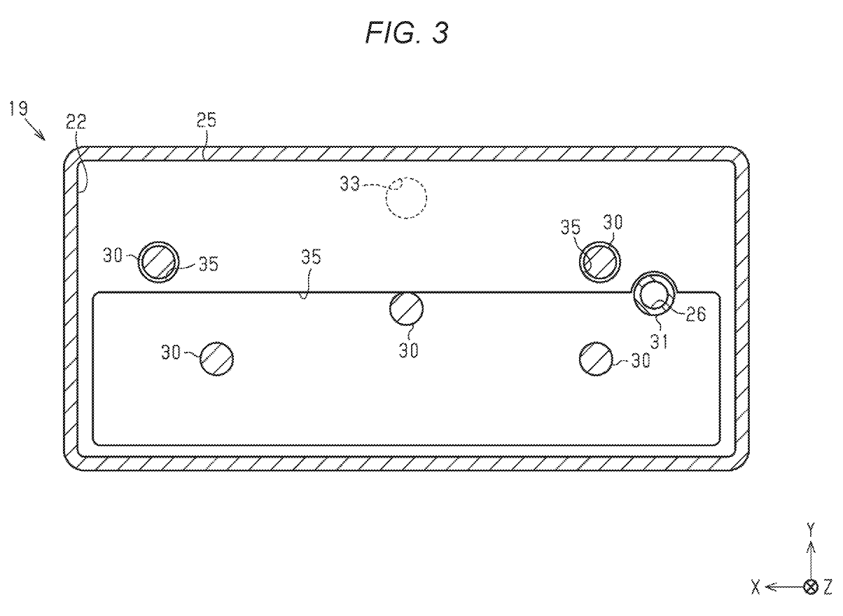

As illustrated in FIG. 3, the shape of the hole 35 is not limited to a circular shape, and may be any shape. The shape of the hole 35 may be, for example, a rectangular shape, a triangular shape, or a hexagonal shape. The plurality of columns 30 may penetrate one hole 35. One or more columns 30 and the open-to-atmosphere cylinder 31 may penetrate one hole 35.

### Second Modification

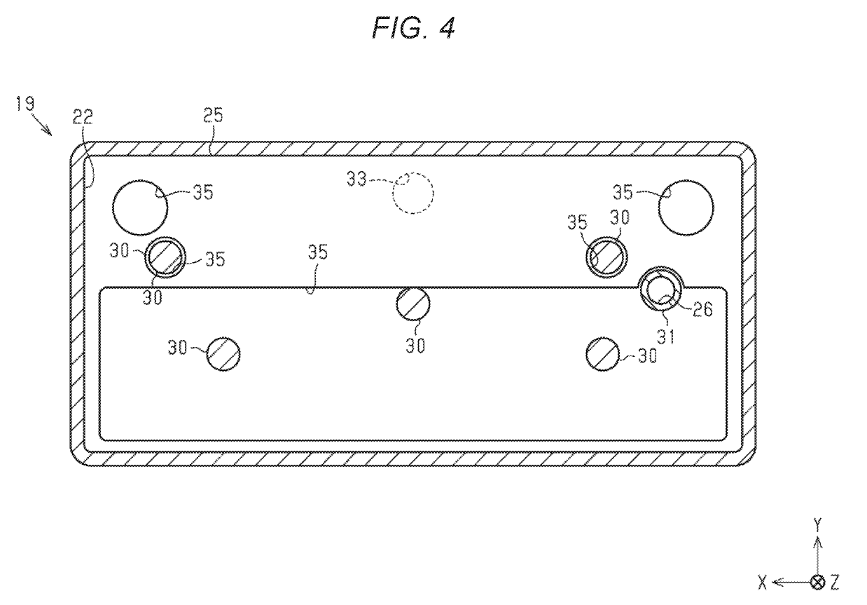

As illustrated in FIG. 4, the plate 25 may have the plurality of holes 35 having different shapes. At least two of the plurality of holes 35 may have different opening areas.

### Third Modification

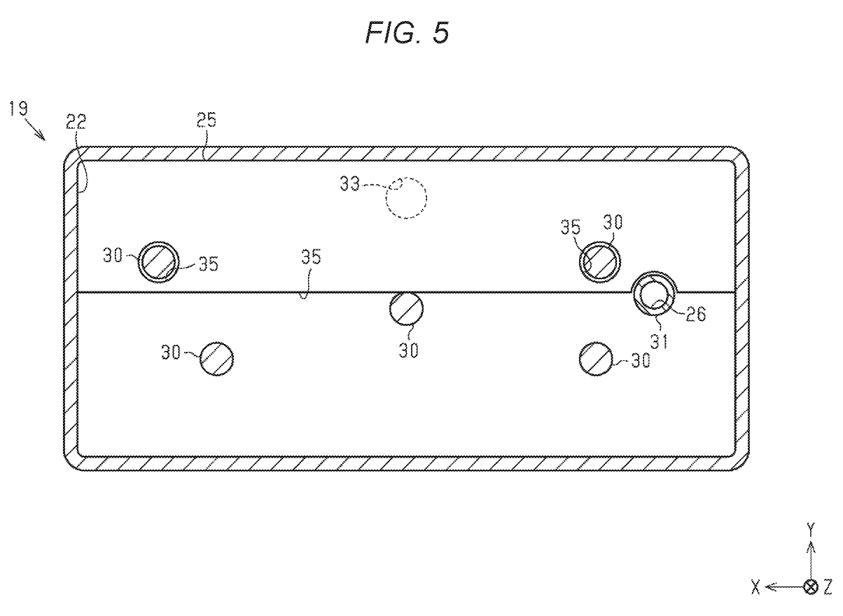

As illustrated in FIG. 5, the shape of the plate 25 may not match the shape of the recess 22. The size of the plate 25 in at least one of the longitudinal direction X and the transverse direction Y may be smaller than a side surface of the recess 22. The hole 35 may be formed between the plate 25 and the side surface of the recess 22.

### Fourth Modification

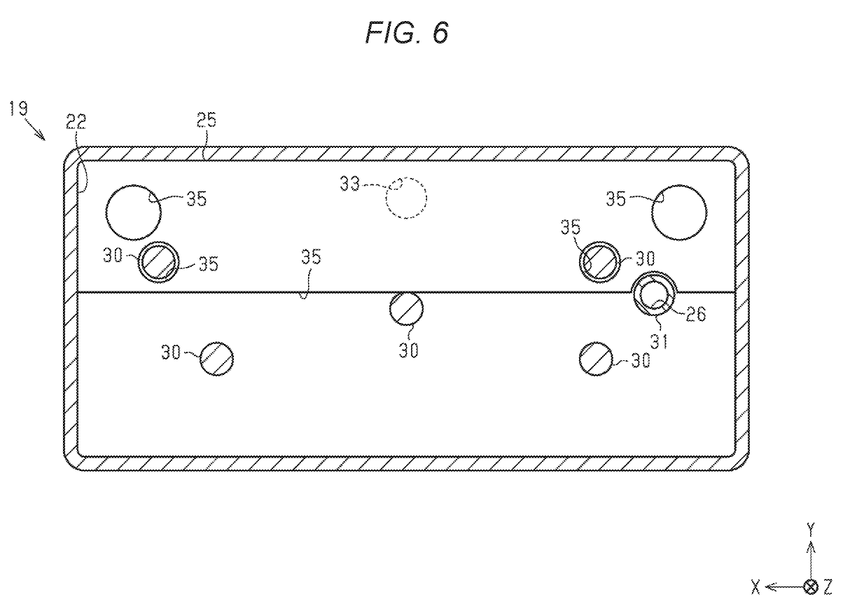

As illustrated in FIG. 6, the plate 25 may have the hole 35 formed between the plate 25 and the side surface of the recess 22, the hole 35 through which the column 30 passes, and the hole 35 through which the first absorber 23 and the second absorber 24 come into contact with each other.

### Other Modifications

The bottom portion 29 may not be a horizontal plane. The bottom portion 29 may have a step. The step may be provided at a position away from the discharge port 33 and above the discharge port 33. The step may be formed integrally with the bottom portion 29 or may be formed by placing a separate member on the bottom portion 29. The separate member constituting the step may be a member that does not absorb the liquid.

The liquid receiving device 19 may include a third absorber having a density lower than that of the first absorber 23. The third absorber may be provided on the first absorber 23. The third absorber may be provided side by side with the first absorber 23 in the horizontal direction at a position away from the hole 35 in the horizontal direction. The third absorber may be provided side by side with the second absorber 24 in the horizontal direction at a position away from the discharge port 33 in the horizontal direction. The third absorber may be provided between the second absorber 24 and the bottom portion 29 at the position away from the discharge port 33 in the horizontal direction.

The plate 25 may have a square shape in the plan view. In this case, the longitudinal direction X and the transverse direction Y may be a direction along one of two sides intersecting at one corner and a direction along the other side, respectively.

The first absorber 23 and the second absorber 24 may have different densities before being accommodated in the recess 22. The first absorber 23 and the second absorber 24 may be accommodated in the recess 22 while maintaining the difference in density.

The first absorber 23 and the second absorber 24 may have the same density before being accommodated in the recess 22. By accommodating the second absorber 24 in the recess 22 so as to compress it more than the first absorber 23, the density of the second absorber 24 may be made higher than the density of the first absorber 23. The second absorber 24 may be compressed in at least one of the longitudinal direction X, the transverse direction Y, and the vertical direction Z.

The density of the first absorber 23 may vary. For example, the density of the first absorber 23 around the hole 35 may be higher than the density of other portions. In the first absorber 23 before being accommodated in the recess 22, the thickness of a peripheral portion of the hole 35 may be larger than the thickness of other portions. The first absorber 23 may be accommodated in the recess 22 such that a portion having a large thickness is compressed. By increasing the density of the first absorber 23 around the hole 35, the liquid absorbed by the first absorber 23 can be easily collected around the hole 35.

The second absorber 24 may have a variation in density. For example, the density of the second absorber 24 around the discharge port 33 may be higher than the density of other portions. In the second absorber 24 before being accommodated in the recess 22, the thickness of a peripheral portion of the discharge port 33 may be larger than the thickness of other portions. The second absorber 24 may be accommodated in the recess 22 such that a portion having a large thickness is compressed. By increasing the density of the second absorber 24 around the discharge port 33, the liquid absorbed by the second absorber 24 can be easily collected around the discharge port 33.

The recess 22 may not include the open-to-atmosphere cylinder 31. In this case, the maintenance device 13 discharges the liquid from the recess 22 in a state where the liquid receiving device 19 is separated from the liquid ejection head 12. Specifically, the maintenance device 13 performs suction cleaning by driving the suction portion 18 in the state in which the liquid receiving device 19 is located at the capping position. The maintenance device 13 stops the suction portion 18 while the liquid receiving device 19 is located at the capping position. Subsequently, after moving the liquid receiving device 19 to the separation position, the maintenance device 13 drives the suction portion 18 again to discharge the liquid from the discharge port 33.

The recess 22 may not include the column 30. The plate 25 may not have the hole 35 through which the column 30 passes.

At least one of the first absorber 23 and the second absorber 24 may be bonded to the plate 25.

The column 30 may be provided on the plate 25. At least one of the first absorber 23 and the second absorber 24 may be supported by the plate 25. The column 30 may support the plate 25. By supporting the plate 25 on the column 30, for example, the possibility that the second absorber 24 is crushed by the weight of the plate 25 can be reduced.

The plurality of holes 35 may have the same size.

Of the plurality of holes 35, the diameter of the hole 35 at a position where the distance from the discharge port 33 is large may be smaller than the diameter of the hole 35 at a position where the distance from the discharge port 33 is small. The plurality of holes 35 having a small diameter may be formed at the position where the distance from the discharge port 33 is large by narrowing intervals between the holes 35. For example, the plurality of holes 35 having a small diameter may be formed in a collected way at the corner portions of the plate 25.

The holes 35 may not be located at the corner portions of the plate 25. The corners of the plate 25 may be cut out. The plate 25 may not be provided at the corner portions of the recess 22.

The plate 25 may be inclined with respect to the horizontal plane.

The liquid ejection apparatus 11 may perform pressurized cleaning. The pressurized cleaning is maintenance for discharging the liquid from the nozzle 15 by pressurizing the liquid upstream of the nozzle 15. The pressurized cleaning discharges bubbles, foreign matter, and the like in the liquid ejection head 12 together with the pressurized liquid. The liquid ejection head 12 may perform idle ejection. The idle ejection is maintenance for ejecting the liquid from the nozzle 15 in order to suppress clogging. The idle ejection is also referred to as flushing. By the idle ejection, for example, the thickened liquid is discharged from the nozzle 15. The liquid receiving device 19 may receive the liquid discharged by at least one of the pressurized cleaning and the idle ejection. In this case, the liquid receiving device 19 may not be in contact with the liquid ejection head 12. The liquid receiving device 19 may be fixed. The liquid receiving device 19 may not include the open-to-atmosphere cylinder 31. The maintenance device 13 may suction and discharge the liquid in the recess 22 from the discharge port 33 while the opening of the recess 22 is open.

The liquid ejection apparatus 11 can be a liquid ejection apparatus that jets or ejects liquids other than ink. The state of the liquid to be ejected from the liquid ejection apparatus as a minute amount of droplet includes a particle state, a teardrop state, and a state of tailing like a thread. The liquid mentioned here may be any material that can be ejected from the liquid ejection apparatus. For example, the liquid may be any substance in a liquid phase and includes a liquid material high or low in viscosity, sol, gel water, other inorganic solvents, organic solvents, solutions, and a fluid material such as a liquid resin, liquid metal, and metal melt. The liquid includes not only a liquid as one state of a substance, but also a liquid obtained by dissolving, dispersing, or mixing particles of a functional material formed of a solid substance such as pigments or metal particles in a solvent. Representative examples of the liquid include the ink described in the above embodiment and a liquid crystal. Here, the term "ink" includes various types of liquid compositions such as general water-based ink, oil-based ink, gel ink, and hot melt ink. Specific examples of the liquid ejection apparatus include an apparatus that ejects a liquid containing, in a dispersed or dissolved form, a material such as an electrode material or a coloring material used for manufacturing, for example, a liquid crystal display, an electroluminescence display, a surface-emitting display, and a color filter. The liquid ejection apparatus may be an apparatus that ejects a bioorganic substance used for manufacturing a biochip, an apparatus that is used as a precision pipette and ejects a liquid to be a sample, a textile printing apparatus, a micro dispenser, or the like. The liquid ejection apparatus may be an apparatus that ejects lubricating oil to a precision machine such as a timepiece or a camera in a pinpoint manner, or an apparatus that ejects a liquid of a transparent resin such as an ultraviolet curable resin onto a substrate in order to form a minute hemispherical lens, an optical lens, or the like, which are used for an optical communication element or the like. The liquid ejection apparatus may be an apparatus that ejects an etching liquid such as acid or alkali in order to etch a substrate or the like.

### Definitions

The expression "at least one" used in the present specification refers to "one or more" of desired options. For example, the expression "at least one" used in the present specification refers to "only one option" or "both of two options" when the number of options is two. As another example, the expression "at least one" used in the present specification means "only one option", "a combination of any two options", or "a combination of any three or more options" when the number of options is three or more.

### Appendices

Technical ideas figured out from the embodiment and the modifications described above and action effects thereof are described below.

[1] A liquid receiving device that receives a liquid discharged from a liquid ejection head includes: a first absorber configured to absorb the liquid; a second absorber disposed below the first absorber in a vertical direction and configured to absorb the liquid; a plate disposed between the first absorber and the second absorber; and a recess configured to accommodate the first absorber, the second absorber, and the plate, in which the recess has a bottom portion in which a discharge port configured to suction and discharge the liquid is formed, the second absorber has a higher density than the first absorber, and the plate blocks movement of the liquid between the first absorber and the second absorber at a position overlapping the discharge port when viewed in the vertical direction.

According to this configuration, the plate blocks the movement of the liquid between the first absorber and the second absorber. The movement of the liquid absorbed by the first absorber from the first absorber to the second absorber is blocked at a position above the discharge port. Therefore, the liquid absorbed by the first absorber moves to the second absorber so as to bypass the plate. Therefore, it is possible to discharge the liquid while reducing the influence of a distance from the discharge port.

[2] In the liquid receiving device according to the above [1], a shape of the plate may match a shape of the recess, and the plate may have a plurality of holes at positions not overlapping the discharge port when viewed in the vertical direction.

According to this configuration, since the shape of the plate matches the shape of the recess, the position of the plate accommodated in the recess can be easily determined. The plate has the plurality of holes. Since the liquid moves from the first absorber to the second absorber via the plurality of holes, a path of the liquid can be easily specified.

[3] In the liquid receiving device according to the above [2], at least one of the plurality of holes is located at a corner portion of the plate.

It is difficult to discharge the liquid absorbed in the portion away from the discharge port. According to this configuration, the at least one hole is located at the corner portion of the plate. Therefore, the liquid in a portion that is difficult to discharge can be efficiently discharged.

[4] In the liquid receiving device according to the above [2] or [3], the plurality of holes may include a first hole whose distance from the discharge port is a first distance, and a second hole whose distance from the discharge port is a second distance larger than the first distance, and a diameter of the second hole may be larger than a diameter of the first hole.

According to this configuration, the second hole far from the discharge port is larger than the first hole close to the discharge port. Since the large hole is located in the portion that is difficult to discharge, the liquid in the portion that is difficult to discharge can be efficiently discharged.

[5] In the liquid receiving device according to any one of the above [2] to [4], the recess may include a column configured to hold the first absorber and the second absorber, and at least one of the plurality of holes may be a hole through which the column passes.

According to this configuration, the column holds the first absorber and the second absorber. Therefore, deviation between the first absorber and the second absorber can be suppressed. The column penetrates a hole of the plate. Therefore, the movement of the liquid along the column can be allowed.

[6] In the liquid receiving device according to any one of the above [2] to [5], the recess may include an open-to-atmosphere cylinder configured to open the recess closed by the liquid ejection head to an atmosphere, and one of the plurality of holes may be a hole through which the open-to-atmosphere cylinder passes.

According to this configuration, the recess includes the open-to-atmosphere cylinder. Therefore, the pressure can be regulated even in a state of being blocked by the liquid ejection head. The open-to-atmosphere cylinder penetrates a hole of the plate. Therefore, the movement of the liquid along the open-to-atmosphere cylinder can be allowed.

[7] A maintenance device includes: the liquid receiving device according to any one of the above [1] to [6]; a waste liquid flow path connected to the discharge port; and a suction portion configured to suction the liquid from the recess.

According to this configuration, it is possible to achieve effects similar to those of the above liquid receiving device.

[8] A liquid ejection apparatus includes: a liquid ejection head configured to eject a liquid; and a liquid receiving device configured to receive the liquid discharged from the liquid ejection head, in which the liquid receiving device includes a first absorber configured to absorb the liquid, a second absorber disposed below the first absorber in a vertical direction and configured to absorb the liquid, a plate disposed between the first absorber and the second absorber, and a recess configured to accommodate the first absorber, the second absorber, and the plate, the recess has a bottom portion in which a discharge port configured to suction and discharge the liquid is formed, the second absorber has a higher density than the first absorber, and the plate blocks movement of the liquid between the first absorber and the second absorber at a position overlapping the discharge port when viewed in the vertical direction.

According to this configuration, it is possible to achieve effects similar to those of the above liquid receiving device.

What is claimed is:

1. A liquid receiving device that receives a liquid discharged from a liquid ejection head, the liquid receiving device comprising:
a first absorber configured to absorb the liquid;
a second absorber disposed below the first absorber in a vertical direction and configured to absorb the liquid;
a plate disposed between the first absorber and the second absorber; and
a recess configured to accommodate the first absorber, the second absorber, and the plate, wherein
the recess has a bottom portion in which a discharge port configured to suction and discharge the liquid is formed,
the second absorber has a higher density than the first absorber, and
the plate blocks movement of the liquid between the first absorber and the second absorber at a position overlapping the discharge port when viewed in the vertical direction.

2. The liquid receiving device according to claim 1, wherein
a shape of the plate matches a shape of the recess, and
the plate has a plurality of holes at positions not overlapping the discharge port when viewed in the vertical direction.

3. The liquid receiving device according to claim 2, wherein
at least one of the plurality of holes is located at a corner portion of the plate.

4. The liquid receiving device according to claim 2, wherein
the plurality of holes include
a first hole whose distance from the discharge port is a first distance, and
a second hole whose distance from the discharge port is a second distance larger than the first distance, and
a diameter of the second hole is larger than a diameter of the first hole.

5. The liquid receiving device according to claim 2, wherein
the recess includes a column configured to hold the first absorber and the second absorber, and
at least one of the plurality of holes is a hole through which the column passes.

6. The liquid receiving device according to claim 2, wherein
the recess includes an open-to-atmosphere cylinder configured to open the recess closed by the liquid ejection head to an atmosphere, and
one of the plurality of holes is a hole through which the open-to-atmosphere cylinder passes.

7. A maintenance device comprising:
the liquid receiving device according to claim 1;
a waste liquid flow path connected to the discharge port; and
a suction portion configured to suction the liquid from the recess.

8. A liquid ejection apparatus comprising:
a liquid ejection head configured to eject a liquid; and
a liquid receiving device configured to receive the liquid discharged from the liquid ejection head, wherein
the liquid receiving device includes
a first absorber configured to absorb the liquid,
a second absorber disposed below the first absorber in a vertical direction and configured to absorb the liquid,
a plate disposed between the first absorber and the second absorber, and
a recess configured to accommodate the first absorber, the second absorber, and the plate,
the recess has a bottom portion in which a discharge port configured to suction and discharge the liquid is formed,
the second absorber has a higher density than the first absorber, and
the plate blocks movement of the liquid between the first absorber and the second absorber at a position overlapping the discharge port when viewed in the vertical direction.
